(19) United States
(12) Patent Application Publication
(10) Pub. No.: US 2023/0205926 A1
(43) Pub. Date: Jun. 29, 2023

(54) SYSTEM AND METHOD FOR PRESERVING PRIVACY FOR A SET OF DATA PACKETS

(71) Applicant: Jio Platforms Limited, Ahmedabad (IN)

(72) Inventors: Tejas Sudam GAIKWAD, Pune (IN); Bhupendra SINHA, Pune (IN); Gaurav DUGGAL, Hyderabad (IN); Manoj Kumar GARG, Morena (IN); Venkateshwaran M, Chennai (IN)

(73) Assignee: Jio Platforms Limited, Ahmedabad (IN)

(21) Appl. No.: 18/145,937

(22) Filed: Dec. 23, 2022

(30) Foreign Application Priority Data
Dec. 24, 2021 (IN) 202121060643

(51) Int. Cl. G06F 21/62

(52) U.S. Cl. CPC G06F 21/6245

(57) ABSTRACT

The present invention provides a robust and effective solution to an entity or an organization by enabling the entity to implement a system for that links together a wide variety of media processing systems to complete complex workflows. The system can be configured to read files in one format, process the files, and export the files in another. The system can be a cross-platform and can be easily ported to various operating systems and can be used to integrate privacy preserving components into the system.

### FIELD OF INVENTION

The embodiments of the present disclosure generally relate to systems and methods for video streaming, and in particular using artificial Intelligence for overcoming privacy threat while video streaming.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

For video streaming pipelines, integration of deep-Learning models into a framework for streaming media gives edge over standard methods. For the new age technological capabilities, the streaming media provides inexpensive and widely deployed cameras, increase in edge to cloud networking capacities, increase in computation capacities and options, and advancements in Deep-Learning networks with increase in accuracy. However, with these advancements, the probability of leakage of the crucial user's data also gets increased with the ease of access and use of technology. In case of video analytics, where a lot of biometric data specific to the users gets exposed which may lead to inappropriate usage of this data for attack purposes called as adversarial attacks. Privacy, being one of the very important aspects to be taken care of while designing the systems for ease of clients, needs to be seriously taken into consideration.

A prior art discloses a system that secures data pipeline which is involved in video stream data processing using ML techniques. It used a hybrid execution environment spanning both CPU and GPU. Used data oblivious algorithms to protect against leakage via memory access pattern side channel attacks. Another prior art proposes a new algorithmic technique for learning and a refined analysis of privacy cost within the framework of differential privacy. It demonstrates differential privacy-based technique that can be applied while training deep neural networks with non-convex objectives that too under modest privacy budget and cost in software complexity, training efficiency and model quality.

Another prior art discloses a differential privacy using stochastic gradient descent method. It preserves the sensitive information by limiting privacy loss obtained by log of prediction w.r.t. average score for a particular class. But it does not perform well of complex dataset. Another prior art discloses a improve privacy, this paper has proposed a method to minimize the number of trainable parameters. They had proposed a transfer learning paradigm that finetunes a space subnetwork with differential privacy. One prior art demonstrates denaturing the video to make it safe from a privacy point of view. It is basically blurring the videos while another prior art targets to de-identify a range of hard and soft biometrics which remain recognizable even after applying blurring. In another prior art, they have combined background subtraction based on gaussian mixtures with improved algorithms to find and segment pedestrians and de-identifying is done by altering the appearance of the segmented pedestrians through neural art algorithm which uses responses of DNN to render the pedestrian images in different style.

One prior art discusses systems and techniques to identify and prevent certain fraud attacks that may be used to defeat facial recognition systems. They proposed a concept of likeness scores that are determined for separate regions that biometric data can be segregated into. By tracking individual likeness scores used in access requests their system is able to detect potential fraud attacks. Another prior art proposes stem and method for facial anti-spoofing by determining a focus value. Focus values represents a point at which the image is sharp which in this case corresponds to a face within an image. Identity check are used everywhere to authenticate user and provide a better user experience. Manual identity check mechanisms often result in high cost of operations, inadequate protection of consumer privacy, and significant potential of fraud. This patent has proposed design a digital identity platform that enables relying parties to perform automatic consumer identity checks using data supplied by identity providers (e.g., DMVs, issuers) both in online and in-store settings. The platform uses advanced cryptographic techniques to enable streamlined identity check operations at scale, protects consumer privacy and reduces potential for fraud.

One prior art provides a system and method for video broadcasting applied to the client side in HLS Internet video play systems while another prior art provides a method named PATE (private aggregation of teacher ensembles) that demonstrate a black box fashion method for trained models on similar type datasets. In this, multiple trained models (Teachers) are used to provide an aggregated information on the new instance because of which the inference (student) cannot access parameters from a specific model and thus the sensitive information access is avoided.

These existing payment solutions rely on either personal device or server-based biometric recognition methods. While these methods work well in practice, they typically trade off either privacy, security or convenience for the user. These articles propose privacy-preserving biometric systems that use advanced cryptographic techniques such as homomorphic encryption and secure multi-party computation to enable secure and seamless payment experiences for users.

There is therefore a need in the art to provide a system and a method that can facilitate integrate privacy preserving components and mitigate the problems associated with the prior art.

### OBJECTS OF THE PRESENT DISCLOSURE

Some of the objects of the present disclosure, which at least one embodiment herein satisfies are as listed herein below.

It is an object of the present disclosure to provide for a system that prevents user specific sensitive information flowing in a streaming media pipeline.

It is an object of the present disclosure to provide for a system that that restricts adversaries from fetching this sensitive information from the DL/ML models present in a streaming media pipeline.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for preserving privacy for a set of data packets. The system may include a video analytics and privacy preserving module (VA-PP) module that may further include one or more processors operatively coupled to one or more first computing devices associated with one or more users. The one or more processors may execute a set of executable instructions that are stored in a memory upon execution of which, the one or more processor may cause the VA-PP module to receive, a first set of data packets from the one or more first computing device, the first set of data packets pertaining to a video stream, decode, from the first set of data packets, a sequence of frames, extract a set of information from the sequence of frames pertaining to sensitive information associated with a user. Based on the set of information extracted, the system may be configured to obtain, by an inference module, a section of interest from the sequence of frames, identify, from the section of interest one or more features of the user associated with the sensitive information and then replace, from the section of interest, the one or more features of the user with a new set of predefined pixels to obtain a new section of interest that is added to the sequence of frames.

In an embodiment, the section of interest may pertain to a plurality of pixels obtained by calculating gradient of the plurality of pixels using prediction probabilities.

In an embodiment, the new set of predefined pixels may provide false color conversion.

In an embodiment, the system may be configured to blur one or more pixels in the section of interest using a blur filter.

In an embodiment, the system may be further configured to provide color conservation and rescaling of the sequence of frames per a sink pad configuration.

In an embodiment, the system may be configured to post process and encode to convert the sequence of frames into an output video stream.

In an embodiment, the VA-PP module may include one or more processed buffers configured to fine-tune the sequence of frames and integrate privacy preserving techniques to preserve the one or more features associated with the user pertaining to the sensitive information.

In an embodiment, the system may be configured to preserve a set of information associated with any or a combination of the one or more features associated with the user pertaining to the sensitive information, the section of interest, the new set of predefined pixels.

In an embodiment, the system may be configured to provide flexibility to modify a set of preference parameters associated with the new set of predefined pixels as per requirements at any stage.

In an aspect, the present disclosure provides for a user equipment (UE) for preserving privacy for a set of data packets. The UE may include a video analytics and privacy preserving module (VA-PP) module that may include a processor operatively coupled to one or more first computing devices associated with one or more users. The processor may execute a set of executable instructions that are stored in a memory upon execution of which, the processor may cause the VA-PP module to receive, a first set of data packets from the one or more first computing device, the first set of data packets pertaining to a video stream, decode, from the first set of data packets, a sequence of frames, extract a set of information from the sequence of frames pertaining to sensitive information associated with a user. Based on the set of information extracted, the system may be configured to obtain, by an inference module, a section of interest from the sequence of frames, identify, from the section of interest one or more features of the user associated with the sensitive information and then replace, from the section of interest, the one or more features of the user with a new set of predefined pixels to obtain a new section of interest that is added to the sequence of frames.

In an aspect, the present disclosure provides for a method for preserving privacy for a set of data packets. The method may include the step of receiving, by a video analytics and privacy preserving module (VA-PP) module, a first set of data packets from the one or more first computing device (104), the first set of data packets pertaining to a video stream. The video analytics and privacy preserving module (VA-PP) module may include one or more processors operatively coupled to one or more first computing devices associated with one or more users. The one or more processors may execute a set of executable instructions that are stored in a memory. The method may further include the steps of decoding, by the VA-PP module, from the first set of data packets, a sequence of frames, extracting, by the VA-PP module, a set of information from the sequence of frames pertaining to sensitive information associated with a user. Based on the set of information extracted, the method may further include the step of obtaining, by an inference module associated with the VA-PP module, a section of interest from the sequence of frames, identifying, by the VA-PP module, from the section of interest one or more features of the user associated with the sensitive information; and then replacing, by the VA-PP module, from the section of interest, the one or more features of the user with a new set of predefined pixels to obtain a new section of interest that is added to the sequence of frames.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which the system of the present disclosure can be implemented, in accordance with an embodiment of the present disclosure.

FIG. 2A illustrates an exemplary representation of system based on an artificial intelligence (AI) based architecture, in accordance with an embodiment of the present disclosure.

FIG. 2B illustrates an exemplary representation of a user equipment (UE) based on an artificial intelligence (AI) based architecture, in accordance with an embodiment of the present disclosure.

FIG. 3 illustrates an exemplary block diagram representation of the system, in accordance with an embodiment of the present disclosure.

FIG. 4 illustrates an exemplary system architecture, in accordance with an embodiment of the present disclosure.

FIG. 5 illustrates an exemplary flow diagram representation of the proposed method, in accordance with an embodiment of the present disclosure.

FIG. 6 illustrates an exemplary VA-PP Inference Plugin Architecture, in accordance with an embodiment of the present disclosure.

FIG. 7 refers to the exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The present invention provides a robust and effective solution to an entity or an organization by enabling the entity to implement a system for that links together a wide variety of media processing systems to complete complex workflows. The system can be configured to read files in one format, process the files, and export the files in another. The system can be a cross-platform and can be easily ported to various operating systems and can be used to integrate privacy preserving components into the system.

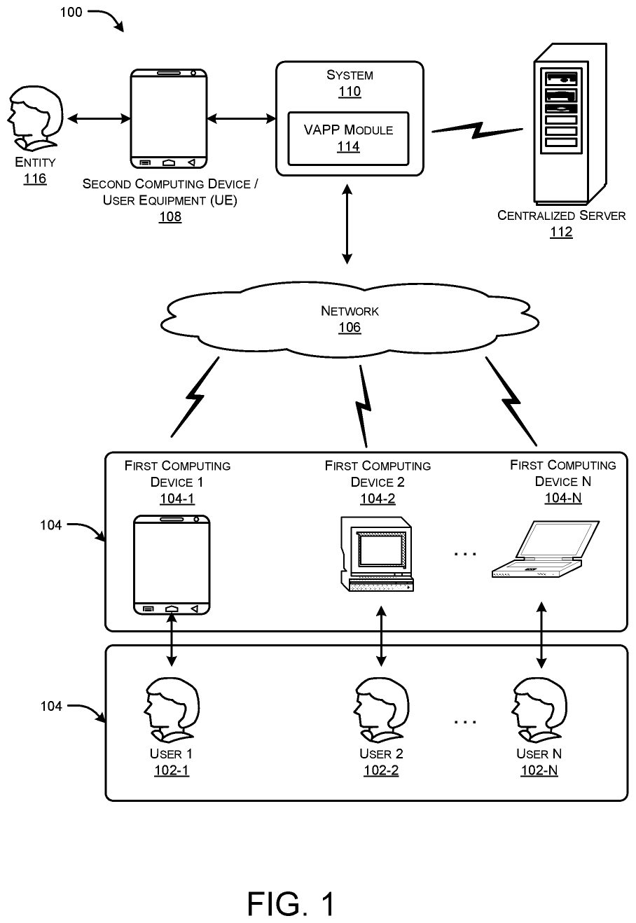

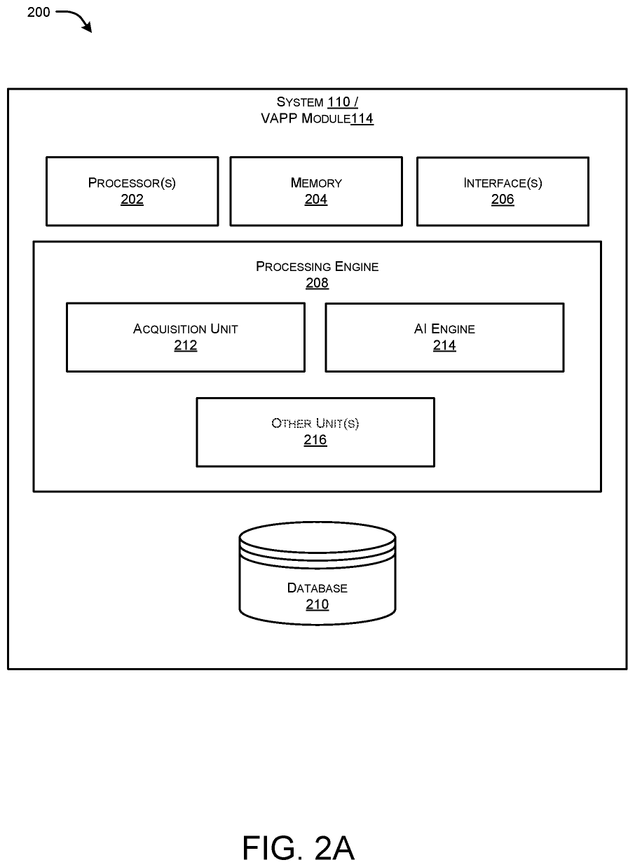

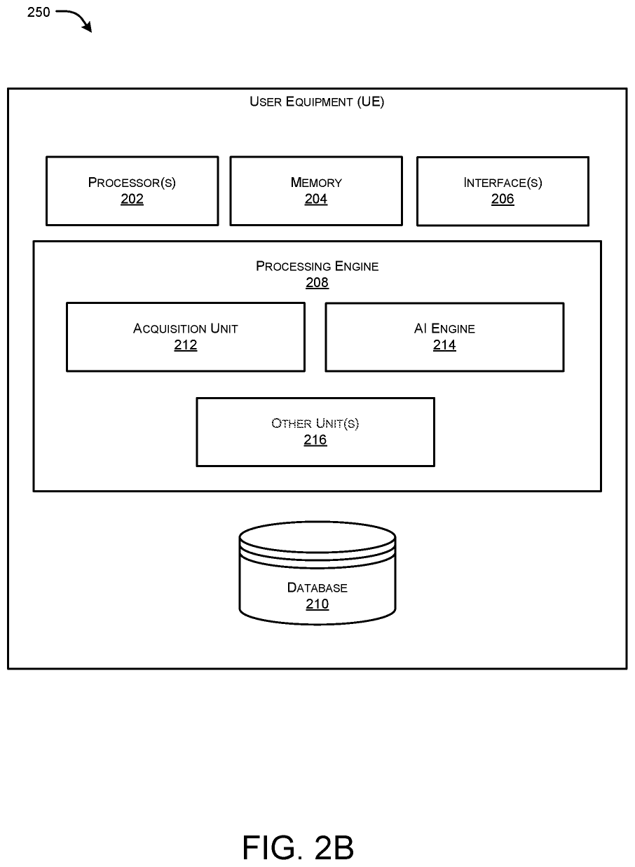

Referring to FIG. 1 that illustrates an exemplary network architecture (100) in which or with which system (110) of the present disclosure can be implemented, in accordance with an embodiment of the present disclosure. As illustrated in FIG. 1, by way of example and not by the limitation, the exemplary architecture (100) may include a plurality of users (102-1, 102-2 . . . 102-N) (collectively referred to as citizens (102) or users (102) or and individually as citizen (102) or user (102)) associated with a plurality of first computing devices (104-1, 104-2, . . . 104-N) (also referred to as user devices (104) or computing devices (104) collectively and user device (104) individually), at least a network (106), at least a centralized server 112 and at least a second computing device (108) associated with an entity (116). More specifically, the exemplary architecture (100) includes a system (110) equipped with a Video Analytics with a Privacy Preserving (VA-PP) module that includes an artificial intelligence engine (214) (Ref FIG. 2A). The user device (104) may be communicably coupled to the centralized server (112) through the network (106) to facilitate communication therewith. As an example, and not by way of limitation, the user computing device (104) may be operatively coupled to the centralised server (112) through the network (106) and may be associated with the entity (116). The entity (116) may include a company, an organisation, a university, a lab facility, a business enterprise, a defence facility, or any other secured facility. In some implementations, the system (110) may be working via the UE (108). The UE (108) can include a handheld device, a smart phone, a laptop, a palm top and the like. The VA-PP module (114) may receive a first set of data packets pertaining to video stream obtained from the computing devices (104) such as like CCTV, video camera, user device and the like. The system (110) may then decode the video stream into a sequence of frames. The system (110) may then provide color conservation and rescaling of the sequence of frames per a sink pad configuration of a framework for streaming media followed by compressed sparse column (CSC)/Scaling element.

The system (110) may extract a set of information from the sequence of frames pertaining to sensitive information. The extracted set of information may be preserved using an Up Gradient-False Color Conversion-with Noise and Adversarial Pixel (UG-FCC-NAP). The inferenced and preserved set of information may be provided to further applications and elements of the system that may include deep learning models followed by inference processes and then post processing and encoding to convert the sequence of frames into an output video stream.

In an exemplary embodiment, the system (110) may be configured to provide flexibility to modify the preference parameters as per requirements at any stage of the project.

In an embodiment, the user computing device (104) may communicate with the system (110) via set of executable instructions residing on any operating system. In an embodiment, user computing device (104) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the user computing device (104) may not be restricted to the mentioned devices and various other devices may be used. A smart computing device may be one of the appropriate systems for storing data and other private/sensitive information.

In an exemplary embodiment, a network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the system (110) may include one or more processors coupled with a memory, wherein the memory may store instructions which when executed by the one or more processors may cause the system to overcome privacy threat while video streaming. FIG. 2 with reference to FIG. 1, illustrates an exemplary representation of system (110)/VA PP module (114) on an artificial intelligence (AI) based architecture, in accordance with an embodiment of the present disclosure. In an aspect, the system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110)/VA PP module (114) may include an interface(s) 206. The interface(s) 206 may comprise a variety of interfaces, for example, interfaces for data input and output devices, referred to as I/O devices, storage devices, and the like. The interface(s) 206 may facilitate communication of the system (110). The interface(s) 206 may also provide a communication pathway for one or more components of the system (110). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a data acquisition engine (212), an artificial intelligence (AI) engine (214), and other engines (216). The other engines (216) may include an inference module, a scaling module, one or more deep learning modules and the like.

FIG. 2B illustrates an exemplary representation (250) of the user equipment (UE) (108), in accordance with an embodiment of the present disclosure. In an aspect, the UE (108) may comprise a processor (222). The processor (222) may be an edge based processor but not limited to it. The processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 226. The interface(s) 226 may comprise a variety of interfaces, for example, interfaces for data input and output devices, referred to as I/O devices, storage devices, and the like. The interface(s) 226 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a data acquisition engine (232), an artificial intelligence (AI) engine (234), and other engines (236). The other engines (236) may include an inference module, a scaling module, one or more deep learning modules and the like.

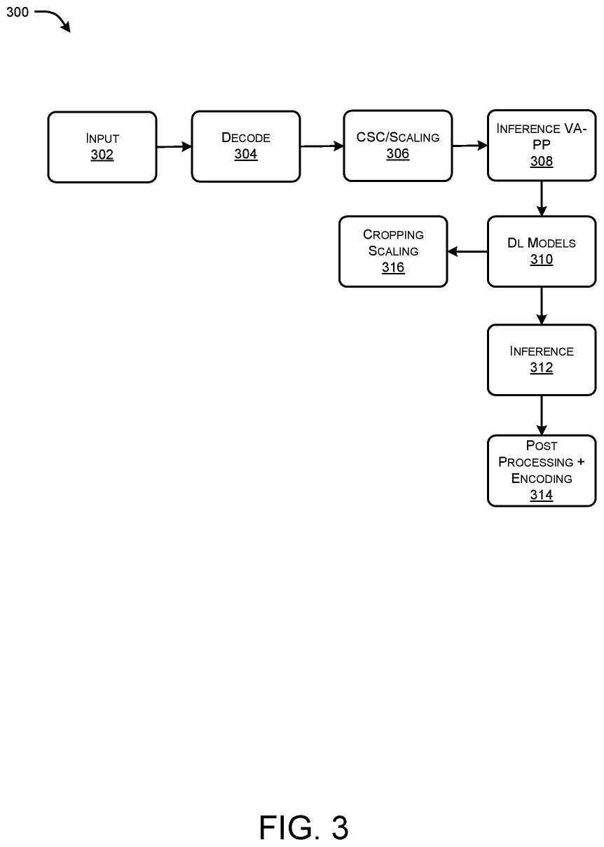

FIG. 3 illustrates an exemplary block diagram representation of the system, in accordance with an embodiment of the present disclosure.

As illustrated in FIG. 3, the input (302) here is a video stream obtained from sources like CCTV, video camera, user device and the like. Which further given to decoder (304) to decode the stream into sequence of frames. These frames are then given to CSC/Scaling block (306) for color conversion and rescaling of the frames as per the sink pad configuration of the streaming media element followed by CSC/Scaling element.

The frames are then sent to inference and Video Analytics with Privacy Preserving (VA-PP) block (308) for preserving the information obtained from the inferencing models and preserving the sensitive information using Up Gradient-False Color Conversion-with Noise and Adversarial Pixel.

The inferenced information with the sensitive data preserved then given to further applications and elements of the streaming media pipeline which includes deep learning models (310) followed by inference processes (312) and then post processing and encoding (314) to convert the sequence of frames into a video stream.

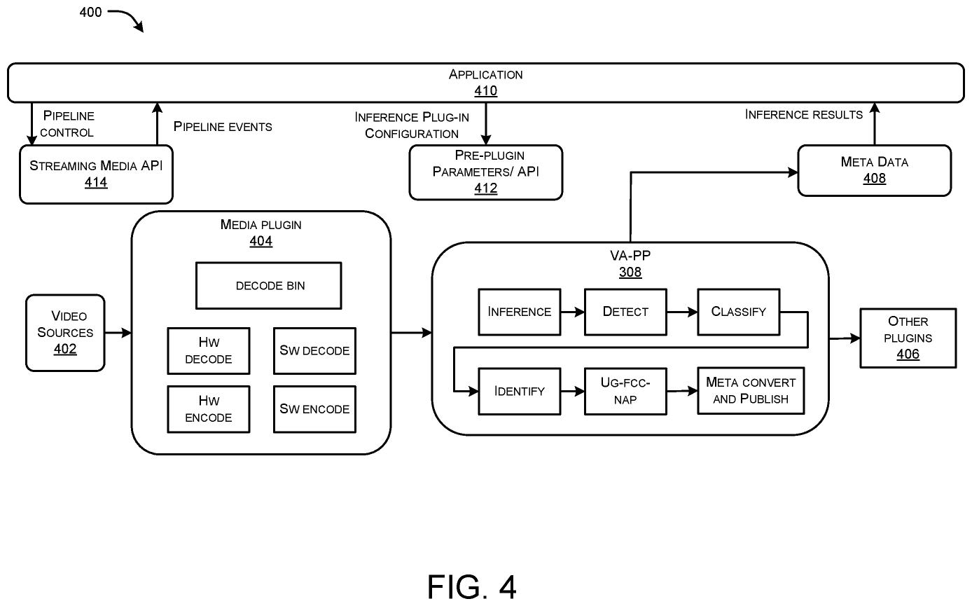

FIG. 4 illustrates an exemplary system architecture, in accordance with an embodiment of the present disclosure. System Architecture. As illustrated, the system architecture (400) for streaming media-based Video Analytics Pipeline may include a VA-PP (308) associated with media plugins (404) and other plugins (408). The media plugin is coupled to one or more video sources (402). A meta data obtained from the VA-PP (308) can be provided to an application block (412) that may include pre plugin parameters (412) and a streaming media application (414).

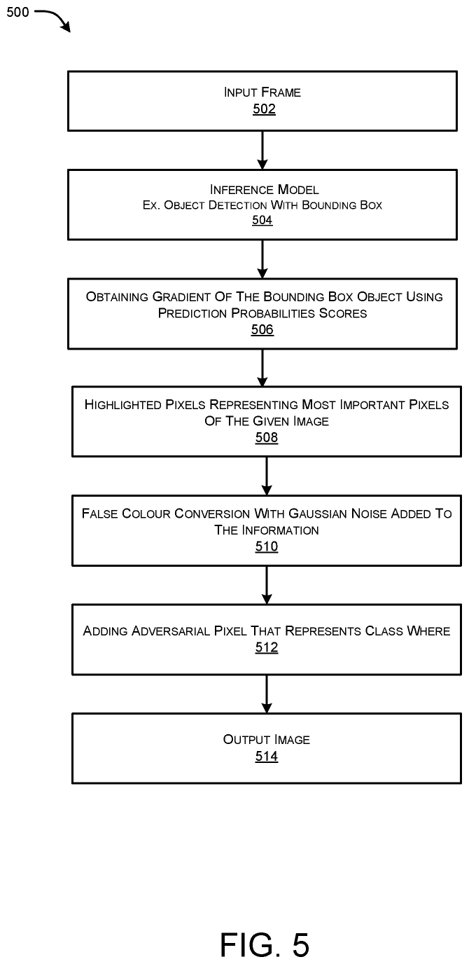

FIG. 5 illustrates an exemplary flow diagram representation of the proposed method, in accordance with an embodiment of the present disclosure. As illustrated, the flow diagram (500) may include an input frame (502) obtained from the decoder is given to the inference block (504) which have deep learning-based models. The deep learning models give out inferred meta-data information, which is used to obtain sections of interest from the input frame (506). The Object image may be obtained from but not limited to a bounding box deep learning model YOLO v4 and the like. An image of interest (IoI) can be obtained from the input image which is then given to deep learning model to obtain pixels that are highly responsible predictions (508). These are obtained by calculating gradients of this IoI using prediction probabilities given by the model. This gradient image of IoI (also referred to as Heat Map of IoI). This heatmap is them used to subtract these important pixels from IoI and replace with important pixels of any other class and provide false color conversion (510) so that, even after blurring, machine learning models cannot identify any other features of the user on the basis of which the user identity can be revealed. For blurring, gaussian blur filter can be used. This processed image is VA-PP IoI as an output of the block (514), which is prone to adversarial attacks that may be targeted or untargeted.

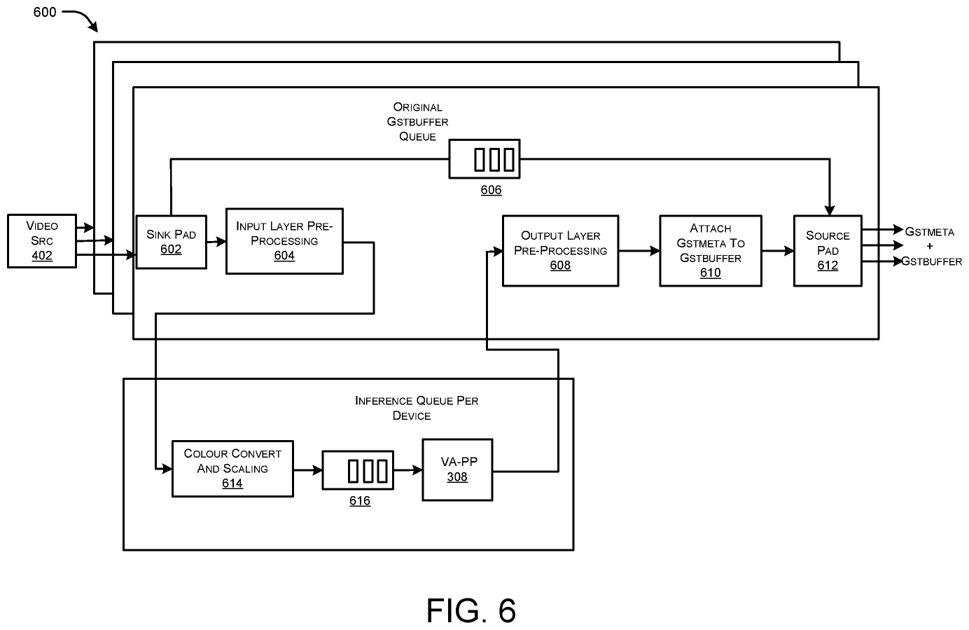

FIG. 6 illustrates an exemplary VA-PP Inference Plugin Architecture (600), in accordance with an embodiment of the present disclosure. As illustrated, VA-PP block (308) is attached with inference block as the information obtained from the information block is processed from VA-PP components to secure the sensitive user specific information like biometrics information of the user. The plugin architecture (600) represents the element for proposed VA-PP structure (308) of streaming media. Input video stream is received from the one or more video sources (402) and the video stream is sent to a sink pad (602) that is coupled to an input layer processing which is further coupled to a color convert and scaling (614). The videos coming through the source pad are pre-processed and given further for scaling and color conversion. Inference queue per device may be obtained and then passed on to the VA-PP block (308). The output frames from the VA-PP (308) may be provided to an output layer processing (608) that is attached to a for example, but not limited to the like, GstMeta to Gst Buffer (610) and then additionally to a source pad (612). These processed buffers are further given to the VA-PP block where these buffers are used to fine-tune the model and integrate privacy preserving technique to preserve user specific sensitive information. The information is then given to output-layer pre-processing and then meta data is extracted as per application requirements.

In an exemplary implementation, Grad represents gradient generated based on prediction probabilities, IoI represents Image of Interest, Delta max represents pixels with high importance in the view of prediction by the model. Px represents perturbed IoI of x class. The Px is obtained by subtracting the highlighted pixels from IoI and adding gradient pixels of other classes that changes the prediction class of the IoI. This Px is the added with noise generated which will result miss classifications and non-identification of the IoI from naked eyes. X here is the present class in IoI and y is the class different from that of x. The equations are given below

Pₓ=Grad_{IoI}−∇max Grad_{IoI}+∇max Grad_{IoI} eq (1)

where y≠x, x and y are classes and Pₓ is perturbed image

Grad_{IoI}=∇(x), where x∈IoI eq(2)

VA PPGₓ=Pₓ+N, N∈Gaussian Noise eq(3)

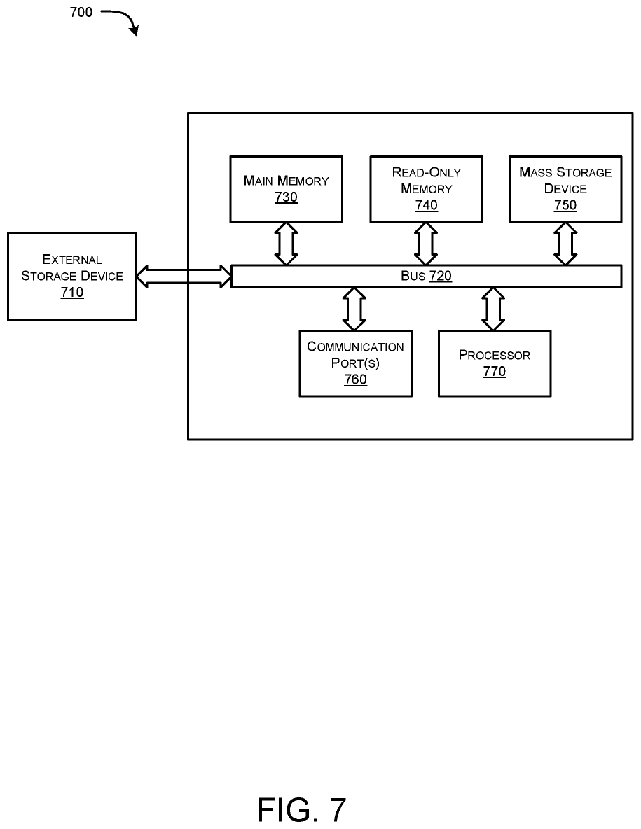

FIG. 7 illustrates an exemplary computer system in which or with which embodiments of the present invention can be utilized in accordance with embodiments of the present disclosure. As shown in FIG. 7, computer system 700 can include an external storage device 710, a bus 720, a main memory 730, a read only memory 740, a mass storage device 750, communication port 760, and a processor 770. A person skilled in the art will appreciate that the computer system may include more than one processor and communication ports. Processor 770 may include various modules associated with embodiments of the present invention. Communication port 760 can be any of an RS-272 port for use with a modem-based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system connects. Memory 730 can be Random Access Memory (RAM), or any other dynamic storage device commonly known in the art. Read-only memory 730 can be any static storage device(s). Mass storage 750 may be any current or future mass storage solution, which can be used to store information and/or instructions.

Bus 720 communicatively couples processor(s) 770 with the other memory, storage and communication blocks. Optionally, operator and administrative interfaces, e.g. a display, keyboard, and a cursor control device, may also be coupled to bus 720 to support direct operator interaction with a computer system. Other operator and administrative interfaces can be provided through network connections connected through communication port 760. Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

We claim:

1. A system (110) for preserving privacy for a set of data packets, said system (110) comprising:
a video analytics and privacy preserving module (VA-PP) module (114), said VA-PP module (114) comprising one or more processors (202), said one or more processors (202) operatively coupled to one or more first computing devices (104) associated with one or more users (102), wherein the one or more processors (202) executes a set of executable instructions that are stored in a memory (204), upon execution of which, the one or more processor (202) causes the VA-PP module (114) to:
receive, a first set of data packets from the one or more first computing device (104), the first set of data packets pertaining to a video stream;
decode, from the first set of data packets, a sequence of frames;
extract a set of information from the sequence of frames pertaining to sensitive information associated with a user;
based on the set of information extracted, obtain, by an inference module, a section of interest from the sequence of frames;
identify, from the section of interest one or more features of the user associated with the sensitive information; and
replace, from the section of interest, the one or more features of the user with a new set of predefined pixels to obtain a new section of interest that is added to the sequence of frames.

2. The system as claimed in claim 1, wherein the section of interest pertains to a plurality of pixels obtained by calculating gradient of the plurality of pixels using prediction probabilities.

3. The system as claimed in claim 1, wherein the new set of predefined pixels provide false color conversion.

4. The system as claimed in claim 1, wherein the system is configured to blur one or more pixels in the section of interest using a blur filter.

5. The system as claimed in claim 1, wherein the system is further configured to provide color conservation and rescaling of the sequence of frames per a sink pad configuration.

6. The system as claimed in claim 1, wherein the system is configured to post process and encode to convert the sequence of frames into an output video stream.

7. The system as claimed in claim 1, wherein the VA-PP module (114) comprises one or more processed buffers configured to fine-tune the sequence of frames and integrate privacy preserving techniques to preserve the one or more features associated with the user pertaining to the sensitive information.

8. The system as claimed in claim 7, wherein the system is configured to preserve a set of information associated with any or a combination of the one or more features associated with the user pertaining to the sensitive information, the section of interest, the new set of predefined pixels.

9. The system as claimed in claim 1, wherein the system is configured to provide flexibility to modify a set of preference parameters associated with the new set of predefined pixels as per requirements at any stage.

10. A user equipment (UE) (108) for preserving privacy for a set of data packets, said user equipment (UE) (108) comprising:
a video analytics and privacy preserving module (VA-PP) module, said VA-PP module (114) comprising a processor (222), said processor (222) operatively coupled to one or more first computing devices (104) associated with one or more users (102), wherein the processor (222) executes a set of executable instructions that are stored in a memory (224), upon execution of which, the processor (222) causes the VA-PP module (114) to:
receive, a first set of data packets from the one or more first computing device (104), the first set of data packets pertaining to a video stream;
decode, from the first set of data packets, a sequence of frames;
extract a set of information from the sequence of frames pertaining to sensitive information associated with a user;
based on the set of information extracted, obtain, by an inference module, a section of interest from the sequence of frames;
identify, from the section of interest one or more features of the user associated with the sensitive information; and
replace, from the section of interest, the one or more features of the user with a new set of predefined pixels to obtain a new section of interest that is added to the sequence of frames.

11. A method for preserving privacy for a set of data packets, said method (110) comprising:
receiving, by a video analytics and privacy preserving module (VA-PP) module (114), a first set of data packets from the one or more first computing device (104), the first set of data packets pertaining to a video stream, wherein the video analytics and privacy preserving module (VA-PP) module (114) comprises one or more processors (202), said one or more processors (202) operatively coupled to one or more first computing devices (104) associated with one or more users (102), wherein the one or more processors (202) executes a set of executable instructions that are stored in a memory (204);
decoding, by the VA-PP module (114), from the first set of data packets, a sequence of frames;
extracting, by the VA-PP module (114), a set of information from the sequence of frames pertaining to sensitive information associated with a user;
based on the set of information extracted, obtaining, by an inference module associated with the VA-PP module (114), a section of interest from the sequence of frames;
identifying, by the VA-PP module (114), from the section of interest one or more features of the user associated with the sensitive information; and
replacing, by the VA-PP module (114), from the section of interest, the one or more features of the user with a new set of predefined pixels to obtain a new section of interest that is added to the sequence of frames.

12. The method as claimed in claim 11, wherein the section of interest pertains to a plurality of pixels obtained by calculating gradient of the plurality of pixels using prediction probabilities.

13. The method as claimed in claim 11, wherein the new set of predefined pixels provide false color conversion.

14. The method as claimed in claim 11, wherein the method comprises a step of blurring one or more pixels in the section of interest using a blur filter.

15. The method as claimed in claim 11, wherein the wherein the method comprises steps of providing color conservation and rescaling of the sequence of frames per a sink pad configuration.

16. The method as claimed in claim 11, wherein the method comprises steps of post processing and encoding to convert the sequence of frames into an output video stream.

17. The method as claimed in claim 11, wherein the method comprises a step of fine-tuning, by using one or more processed buffers associated with the VA-PP module, the sequence of frames and integrate privacy preserving techniques to preserve the one or more features associated with the user pertaining to the sensitive information.

18. The method as claimed in claim 7, wherein the method comprises a step of preserving a set of information associated with any or a combination of the one or more features associated with the user pertaining to the sensitive information, the section of interest, the new set of predefined pixels.

19. The method as claimed in claim 11, wherein the method comprises a step of providing flexibility to modify a set of preference parameters associated with the new set of predefined pixels as per requirements at any stage.
